(19) United States
(12) Patent Application Publication
(10) Pub. No.: US 2002/0154260 A1
(43) Pub. Date: Oct. 24, 2002

(54) Light-scattering sheets and liquid crystal display devices

(76) Inventors: Tatsuo Uchida, Sendai-shi (JP); Hiroyuki Takemoto, Himeji-shi (JP); Yoshiyuki Nishida, Nagareyama-shi (JP); Hiroshi Takahashi, Himeji-shi (JP)

Correspondence Address: BIRCH STEWART KOLASCH & BIRCH, PO BOX 747, FALLS CHURCH, VA, 22040-0747, US

(21) Appl. No.: 09/961,287

(22) Filed: Sep. 25, 2001

(30) Foreign Application Priority Data
Jan. 26, 2001 (JP) 18821/2001

(51) Int. Cl. G02F 1/1335

(52) U.S. Cl. 349/112; 349/113

(57) ABSTRACT

The reflective liquid crystal display device comprises a polarizing plate 11 disposed forwardly of the liquid crystal cell 16, a reflecting means 15 disposed on backside of the liquid crystal cell, and a light-scattering sheet 12 disposed forwardly of reflecting means. The light-scattering sheet can be prepared by phase-separating a plurality of resins varying in refractive index due to spinodal decomposition and forming a light-scattering layer scattering an incident light isotropically. The light-scattering layer has a ratio of a linearly transmitted light to an incident light of 0.1 to 15% and has a phase separation structure having an average interphase distance of 3 to 15 μm. The light-scattering layer expresses a light-scattering intensity profile having substantially flat area at scattering angle θ of 3 to 12° from a scattering center. According to the light-scattering sheet, the uniform brightness can be imparted to the display of the liquid crystal display device even when the viewing angle changes.

### FIELD OF THE INVENTION

The present invention relates to a transmittable light-scattering sheet (or film) useful for assuring a high-luminance display of images in a liquid crystal display device (in particular, reflective liquid crystal display), a method of producing the same, and a reflective liquid crystal display device utilizing the light-scattering sheet.

### BACKGROUND OF THE INVENTION

In a backlight type display device (liquid crystal display device) illuminating a display panel from its backside, a flat or surface light source unit (or a back light unit) is disposed on the backside of the display panel. The surface light source unit comprises, for example, a tubular light source such as fluorescent tube (cold cathode tube) disposed adjacent to a lateral side of a light guide, the light guide for guiding a light from the tubular light source to a display panel, and a reflector disposed opposite to the display panel side of the light guide. In such a surface light source unit, since a light from a fluorescent tube is reflected by a reflector and guided by a light guide, a diffusing film is usually disposed between the tubular light source and the display panel for the purpose of uniformly illuminating a display panel from behind.

Japanese Patent Application Laid-Open No. 27904/1995 (JP-7-27904A) and 113902/1997 (JP-9-113902A) disclose a transmittable liquid crystal display device in which a particulate-scattering sheet having an islands-in-an ocean structure composed of a plastic bead and a transparent resin is disposed between a backlight and a liquid crystal cell. Japanese Patent Application Laid-Open No. 114013/1995 (JP-7-114013A) discloses a liquid crystal display device in which a film or a sheet capable of scattering and transmitting an incident light is disposed on a display screen in order to improve viewing angle properties. The literature discloses a film or a sheet in which a dispersed phase particle composed of a transparent resin and having a ratio of longitudinal axis to minor axis of not less than 10 and an average particle size of 0.5 to 70 μm is dispersed in a transparent resin matrix.

However, in a display device with the use of a tubular light source having anisotropy in an emission distribution (luminance distribution), it is difficult to illuminate a display panel with uniform luminance even if using these films or sheets.

Japanese Patent Application Laid-Open No. 84376/1999 (JP-11-84376A) discloses, as a backlight unit for illuminating a transmittable liquid crystal display panel with uniform luminance, a backlight unit comprising a light guide for guiding a projected light to the display panel, a fluorescent lamp disposed in proximity to one side of the light guide, a reflector for reflecting a light from the fluorescent lamp toward a front direction (a direction of a display panel), a diffusion plate for diffusing a emerge light dispersed from emerge surface of the light guide to be uniform, which is disposed on the front side of the light guide, and a prism sheet for gathering a light from the diffusion plate. The literature describes an example of unit comprising a pair of prism sheets disposed oppositely with aligning the extended direction of the prisms toward a crossing direction each other, and diffusion plates disposed on both sides of the prism sheets.

Since a plurality of prism sheets and a plurality of diffusion plates are required for such a backlight unit, its structure is complicated and its luminance is lowered. Moreover, even when the above backlight unit is employed, its luminance distribution is not still uniform. Thus, although an emission distribution (luminance distribution) in the longitudinal direction (x-axis direction) of the fluorescent tube (cold cathode tube) is relatively uniform, the emission distribution (luminance distribution) in the Y-axis direction normal to the X-axis direction of the fluorescent tube has a streak-like directionality (linear dark areas) and is not still uniform.

On the other hand, a reflecting liquid crystal display device as a display device brightening the display screen by exploiting natural light is considered to be most promising for replacing the backlight-mode liquid crystal display. As a liquid crystal display elements constituting the reflecting liquid crystal display device, there is known a variety of elements such as TN (Twisted Nematic) and STN (Super Twisted Nematic) elements, but elements utilizing a polarizer (one polarizing plate type) is preferred for color display and high-definition display. In such a reflective liquid crystal display device, in order to insure the uniform brightness of the screen, the scattering function is an important factor. That is, in the reflective liquid crystal display device, the brightness of the screen is insured in such manner that the light incident on the liquid crystal layer (natural light, ambient light) is efficiently taken in and reflected with a reflector, and the reflected light is scattered to an extent not deteriorating visibility for the prevention of total reflection. When the polarizer and light-scattering sheet are combined, the reflection efficiency can be further improved. However, when the reflective liquid crystal display device is to be a color display, a color filter is used in addition to the polarizer. In case where a color filter is used, the proportion of loss of reflected light is increased and the above scattering plate system cannot impart enough brightness to the display screen.

For the purpose of insuring a high luminance by scattering reflected light, there is also known a liquid crystal display device with a transmittable light-scattering sheet. For example, Japanese Patent Publication No. 8430/1986 (JP-61-8430B) discloses a liquid crystal display device comprising a polarizing layer formed on the front side of a liquid crystal cell and, as formed thereon, a light-scattering layer. Japanese Patent Application Laid-Open No. 261171/1995 (JP-7-261171A) discloses a display device having a light-scattering layer externally of a liquid cell, specifically a display device comprising a polarizing film on the outer surface of an electrode plate and, as formed on the surface of the polarizing film, a light-scattering layer comprising a phase separated dispersion of two or more kinds of resins varying in refractive index.

However, in these islands-in-an ocean structure sheets, since the resin beads are dispersed randomly in a transparent resin matrix, the scattering light intensity distributes according to Gaussian distribution in principle. Thus, although an area around the scattering center is bright, the brightness is suddenly decreased as being apart from the scattering center, and it is difficult that the uniform brightness is imparted to the display surface. Particularly, in respect to the particle dispersed sheet, the brightness of the reflected light from a reflector is increased in the reflective liquid crystal display device having a large display screen, so that the sufficient brightness can not imparted to the periphery of the display screen. On the other hand, the brightness is imparted to the whole display screen to some extent, so that the display screen goes dark as a whole and the visibility is lowered. Therefore, it is difficult in the reflective liquid crystal display device having a relatively large display screen such as a reflective liquid crystal display device having 1.5 inch or more display surface area that the whole display screen is illuminated uniformly.

Further, although the viewing angle against the liquid crystal display surface extends by utilizing the light-scattering layer, the brightness of the display surface considerably changes according to the viewing angle. Therefore, it is difficult that the uniform brightness is imparted to the display surface over the wide viewing angles. Further, the quality of the outward appearance (external appearance) of the light-scattering sheet is sometimes deteriorated due to giving rainbow-color and strongly reflecting a light source configuration on the sheet according to the species of the light-scattering layer.

### SUMMARY OF THE INVENTION

It is, therefore, an object of the present invention to provide a light-scattering sheet (or film) capable of imparting high diffusibility to a transmitted and diffused light and illuminating the whole screen uniformly, and a liquid crystal display device (e.g., reflective liquid crystal display device) with the light-scattering sheet.

It is another object of the present invention to provide a light-scattering sheet capable of imparting the uniform brightness to the display surface even when the viewing angle changes, and a liquid crystal display device with the light-scattering sheet.

It is still another object of the present invention to provide a light-scattering sheet capable of imparting the uniform brightness to the display surface even in large display surface with inhibiting appearance of rainbow-color and reflection of the light source configuration, and a liquid crystal display device with the light-scattering sheet.

The inventors of the present invention did much research to accomplish the above objects and found that by causing spinodal decomposition of a resin composition composed of a plurality of resins varying in refractive index (e.g., causing spinodal decomposition under a suitable condition by evaporating or removing a solvent from a homogenous solution containing the constituting resin) to form the phase separation structure having the specific linearly transmittance to an incident light and the specific average interphase distance, such light-scattering properties that the local brightness at a scattering center can be inhibited, rainbow-color does not appears and that the uniform light-scattering intensity shows at wide scattering angle can be obtained. The present invention has been developed on the basis of the above findings.

Thus, the light-scattering sheet (in particular, transmittable light-scattering sheet) of the present invention comprises a plurality of resins varying in refractive index and scatters an incident light isotropically. The light-scattering layer has a ratio of a linearly transmitted light to an incident light of 0.1 to 15% and has a phase separation structure having an average interphase distance of 3 to 15 μm. The light-scattering layer has a feature that the light-scattering intensity is uniform at wide scattering angle range or diffusing angle range (in other words, wide viewing angle), and expresses a light-scattering intensity profile having substantially flat area at scattering angle θ of 3 to 12° from a scattering center. Especially, a light transmits plural times (at least twice) through the light-scattering layer, a flat area having no infection point appears in the light-scattering intensity profile. Further, in the light-scattering layer, the scattering angle range that an intensity of a diffused light is not less than 80% relative to a maximum intensity of a diffused light is 8 to 25° in respect to a light-scattering property so that the uniform brightness can be imparted to the display screen even when the viewing angle varies. The light-scattering layer may have a phase separation structure composed of a plurality of resins varying in refractive index, and have a bicontinuous phase structure formed by spinodal decomposition or an intermediate structure between the bicontinuous phase structure and a droplet phase structure. Further, the light-scattering sheet or the light-diffusing sheet may comprise the light-scattering layer alone, or a transparent or reflective support and the light-scattering layer formed on at least one side of the support.

The light-scattering sheet (or the light-diffusing sheet) can be utilized in a variety of devices, for example, a reflective-type or a backlight-type liquid crystal display device. The liquid crystal display device usually comprises a liquid crystal cell having a liquid crystal sealed therein, a lightening means for illuminating the liquid crystal cell due to reflection or emergence disposed behind the liquid crystal cell, and the light-scattering sheet disposed forwardly of the lightening means. The reflective liquid crystal display device usually comprises a liquid crystal cell having a liquid crystal sealed therein, a reflecting means for reflecting an incident light disposed behind the liquid crystal cell, and the light-scattering sheet disposed forwardly of the reflecting means. Incidentally, the reflective liquid crystal display device in which a polarizer is disposed forwardly of the liquid crystal cell, the light-scattering sheet may be disposed between the liquid crystal cell and the polarizing plate.

Throughout this specification, the term “sheet” means, without regard to thickness, a dimensional material thus meaning a film as well. Moreover, a light-scattering sheet is sometimes referred to as light-diffusing sheet, and “scattering” is sometimes used as a synonym of “diffusing”.

### BRIEF DESCRIPTION OF THE DRAWINGS

FIG. 1 is a schematic side-view showing an instrument for measuring a linearly transmittance.

FIG. 2 is a schematic cross-section view showing an example of the reflective liquid crystal display device.

FIG. 3 is a transmission optical microscope photograph showing the phase separation structure of film obtained in Example 1.

FIG. 4 is a graph showing the light-diffusing properties of the films obtained in Examples 1 and Comparative Example 1.

FIG. 5 is a transmission optical microscope photograph showing the phase separation structure obtained in Example 2.

FIG. 6 is a transmission optical microscope photograph showing the phase separation structure obtained in Example 3.

FIG. 7 is a transmission optical microscope photograph showing the phase separation structure obtained in Example 4.

FIG. 8 is a transmission optical microscope photograph showing the phase separation structure obtained in Example 5.

FIG. 9 is a transmission optical microscope photograph showing the phase separation structure obtained in Example 6.

FIG. 10 is a graph showing the light-diffusing properties of the films obtained in Examples 2 and 3.

FIG. 11 is a graph showing the light-diffusing properties of the films obtained in Examples 4 and 5.

FIG. 12 is a graph showing the light-diffusing property of the film obtained in Example 6.

FIG. 13 is a graph showing the light-diffusing properties of the films obtained in Examples 7 and 8.

FIG. 14 is a graph showing the light-diffusing properties of the films obtained in Examples 9 and 10.

FIG. 15 is a graph showing the light-diffusing property of the film obtained in Example 11.

FIG. 16 is a graph showing the reflective diffusing property of the film obtained in Comparative Example 2.

FIG. 17 is a graph showing the reflective diffusing property of the film obtained in Comparative Example 3.

### DETAILED DESCRIPTION OF THE INVENTION

[Light-Scattering Sheet]

A light-scattering layer constituting a light-scattering sheet (a transmittable light-scattering sheet) comprises a plurality of resins varying in refractive index. A plurality of resins can be employed in combination so that the refractive index difference is for example about 0.01 to 0.2 (e.g., about 0.01 to 0.1), and preferably about 0.1 to 0.15.

A plurality of resins can be suitably selected from styrenic resins, (meth)acrylic resins, vinyl ester-series resins, vinyl ether-series resins, halogen-containing resins, olefinic resins (inclusive of alicyclic olefinic resins), polycarbonate-series resins, polyester-series resins, polyamide-series resins, thermoplastic polyurethane-series resins, polysulfone-series resins (e.g., polyether sulfone, polysulfone), polyphenylene ether-series resins (e.g., a polymer of 2,6-xylenol), cellulose derivatives (e.g., cellulose esters, cellulose carbamates, cellulose ethers), silicone resins (e.g., polydimethyl siloxane, polymethyl phenyl siloxane), rubbers or elastomers (e.g., diene-series rubbers such as polybutadiene and polyisoprene, styrene-butadiene copolymer, styrene-butadiene copolymer, acrylonitrile-butadiene copolymer, acrylic rubber, urethane rubber, silicone rubber).

The styrenic resin includes homo- or copolymers of styrenic monomers (e.g. polystyrene, styrene-α-methylstyrene copolymer, styrene-vinyl toluene copolymer) and copolymers of styrenic monomers with copolymerizable monomers (e.g. a (meth)acrylic monomer, maleic anhydride, a maleimide-series monomer, a diene). The styrenic copolymer includes, for example, styrene-acrylonitrile copolymer (AS resin), a copolymer of styrene and a (meth)acrylic monomer [e.g., styrene-methyl methacrylate copolymer, styrene-methyl methacrylate- (meth)acrylate copolymer, styrene-methyl methacrylate-(meth)acrylic acid copolymer], styrene-maleic anhydride copolymer. The preferred styrenic resin includes polystyrene, a copolymer of styrene and a (meth)acrylic monomer [e.g., a copolymer comprising styrene and methyl methacrylate as main component such as styrene-methyl methacrylate copolymer], AS resin, styrene-butadiene copolymer and the like.

As the (meth)acrylic resin, a homo- or copolymer of a (meth)acrylic monomer and a copolymer of a (meth)acrylic monomer and a coplymerizable monomer can be employed. As the (meth)acrylic monomer, there may be mentioned, for example, (meth)acrylic acid; C₁₋₁₀alkyl (meth)acrylates such as methyl (meth)acrylate, ethyl (meth)acrylate, butyl (meth)acrylate, t-butyl (meth)acrylate, isobutyl (meth)acrylate, hexyl (meth)acrylate, octyl (meth)acrylate and 2-ethylhexyl (meth)acrylate; aryl (meth)acrylates such as phenyl (meth)acrylate; hydroxyalkyl (meth)acrylate such as hydroxyethyl (meth)acrylate and hydroxypropyl (meth)acrylate; glycidyl (meth)acrylate; N,N-dialkylaminoalkyl (meth)acrylate (meth)acrylonitrile; (meth)acrylate having an alicyclic hydrocarbon ring such as tricyclodecane. The copolymerizable monomer includes the above styrenic monomer, a vinyl ester-series monomer, maleic anhydride, maleic acid, and fumaric acid. These monomers can be used singly or in combination.

As the (meth)acrylic resin, there may be mentioned poly(meth)acrylates such as polymethyl methacrylate, methyl methacrylate-(meth)acrylic acid copolymers, methyl methacrylate-(meth)acrylate copolymers, methyl methacrylate-acrylate-(meth)acrylic acid copolymers, and (meth)acrylate-styrene copolymers (MS resin). The preferred (meth)acrylic resin includes poly(C₁₋₆alkyl (meth)acrylate) such as poly(methyl (meth)acrylate) and in particular, methyl methacrylate-series resin comprising methyl methacrylate as main component (about 50 to 100% by weight, preferably about 70 to 100% by weight).

The vinyl ester-series resin includes homo- or copolymers of vinyl ester-series monomers (e.g. polyvinyl acetate, polyvinyl propionate), copolymers of vinyl ester-series monomers with copolymerizable monomers (e.g. ethylene-vinyl acetate copolymer, vinyl acetate-vinyl chloride copolymer, vinyl acetate-(meth)acrylate copolymer) and derivatives thereof. The derivative of the vinyl ester-series resin includes polyvinyl alcohol, ethylene-vinyl alcohol copolymer, polyvinyl acetal resin and the like.

As the vinyl ether-series resins, there may be mentioned a homo- or copolymer of vinyl C₁₋₁₀alkyl ether such as vinyl methyl ether, vinyl ethyl ether, vinyl propyl ether, and vinyl t-butyl ether, a copolymer of vinyl C₁₋₁₀alkyl ether and a copolymerizable monomer (e.g., vinyl alkyl ether-maleic anhydride copolymer).

The halogen-containing resin includes polyvinyl chloride, poly(vinylidene fluoride), vinyl chloride-vinyl acetate copolymer, vinyl chloride-(meth)acrylate copolymer, and vinylidene chloride-(meth)acrylate copolymer.

The olefinic resin includes homopolymers of olefins such as polyethylene and polypropylene, copolymers such as ethylene-vinyl acetate copolymer, ethylene-vinyl alcohol copolymer, ethylene-(meth)acrylic acid copolymer and ethylene-(meth)acrylate copolymer. As the alicyclic olefinic resin, there may be mentioned homo- or copolymers of cyclic olefins such as norbornene and dicyclopentadiene (e.g., a polymer having an alicyclic hydrocarbon group such as tricyclodecane which is sterically rigid), copolymers of the cyclic olefin with a copolymerizable monomer (e.g., ethylene-norbornene copolymer, propylene-norbornene copolymer). The alicyclic olefinic resin can be commercially available as, for example, the trade name “ARTON”, the trade name “ZEONEX” an the like.

The polycarbonate-series resin includes aromatic polycarbonates based on bisphenols (e.g. bisphenolA) and aliphatic polycarbonates such as diethylene glycol bisallyl carbonates.

The polyester-series resin includes aromatic polyesters obtainable from an aromatic dicarboxylic acid, such as terephthalic acid (homopolyesters, e.g. polyC₂₋₄alkylene terephthalates such as polyethylene terephthalate and polybutylene terephthalate, polyC₂₋₄alkylene naphthalates and copolyesters comprising a C₂₋₄alkylene arylate unit (a C₂₋₄alkylene terephthalate unit and/or a C₂₋₄alkylene naphthalate unit) as a main component (e.g., not less than 50% by weight). The copolyester includes copolyesters in which, in constituting units of a polyC₂₋₄alkylene arylate, a part of C₂₋₄alkylene glycols is substituted with a polyoxyC₂₋₄alkylene glycol, a C₆₋₁₀alkylene glycol, an alicyclic diol (e.g., cyclohexane dimethanol, hydrogenated bisphenolA), a diol having an aromatic ring (e.g., 9,9-bis(4-(2-hydroxyethoxy)phenyl)fluorene having a fluorenone side chain, a bisphenolA, bisphenolA-alkylene oxide adduct) or the like, and copolyesters which, in constituting units, a part of aromatic dicarboxylic acids is substituted with an unsymmetric aromatic dicarboxylic acid such as phthalic acid and isophthalic acid, an aliphatic C₆₋₁₂dicarboxylic acid such as adipic acid or the like. The polyester-series resin also includes polyarylate-series resins, aliphatic polyesters obtainable from an aliphatic dicarboxylic acid such as adipic acid, a homo- or copolymer of a lactone such as E-caprolactone. The polyester-series resins may be crystalline polyesters, and usually non-crystalline polyesters, for example, non-crystalline copolyesters (e.g., C₂₋₄alkylene arylate-series copolyesters).

The polyamide-series resin includes aliphatic polyamides such as nylon 46, nylon 6, nylon 66, nylon 610, nylon 612, nylon 11, and nylon 12, a polyamide obtained from a dicarboxylic acid (e.g., terephthalic acid, isophthalic acid, adipic acid) and a diamine (e.g., hexamethylene diamine, m-xylylenediamine). The polyamide-series resin may be homo- or copolymer of a lactam such as e-caprolactam, and is not limited to a homopolyamide but may be a copolyamide.

Among the cellulose derivatives, the cellulose esters includes, for example, aliphatic organic acid esters (e.g., cellulose acetates such as cellulose diacetate and cellulose triacetate; C₁₋₆oraganic acid esters such as cellulose propionate, cellulose butylate, cellulose acetate propionate, and cellulose acetate butylate), aromatic organic acid esters (e.g. C₇₋₁₂aromatic carboxylic acid esters such as cellulose phthalate and cellulose benzoate), inorganic acid esters (e.g., cellulose phosphate, cellulose sulfate), and may be mixed acid esters such as acetate nitrate cellulose ester. The cellulose derivatives also includes cellulose carbamates (e.g. cellulose phenylcarbamate), cellulose ethers (e.g., cyanoethylcellulose, hydroxyC₂₋₄alkyl celluloses such as hydroxyethylcellulose and hydroxypropylcellulose C₁₋₆alkyl cellulose such as methyl cellulose and ethyl cellulose; carboxymethyl cellulose or a salt thereof, benzyl cellulose, acetyl alkyl cellulose).

The preferred resin includes, for example, styrenic resins, (meth)acrylic resins, vinyl ester-series resins, vinyl ether-series resins, halogen-containing resins, alicyclic olefinic resins, polycarbonate-series resins, polyester-series resins, polyamide-series resins, cellulose derivatives, silicone-series resins, rubbers or elastomers, and the like. As a plurality of resins, a resin which is usually non-crystalline and soluble in an organic solvent (in particular, a common solvent in which a plurality of resins can be dissolved) can be used. In particular, a resin having the excellent moldability, film-forming property, transparent and weather resistance, for example,. styrenic resins, (meth)acrylic resins, alicyclic olefinic resins, polyester-series resins, cellulose derivatives (e.g., cellulose esters) are preferred.

A plurality of resins can be suitably used in combination. For example, in respect to a combination of a plurality of resins, a cellulose derivative, in particular, a cellulose ester (e.g., a cellulose C₂₋₄alkyl carboxylic acid ester such as cellulose diacetate, cellulose triacetate, cellulose acetate propionate and cellulose acetate butylate) is employed as at least one resin, and the cellulose derivative may be combined with the other resins.

The glass transition temperature can be selected within the range of about −100° C. to 250° C., preferably about −50° C. to 230° C., more preferably about 0 to 200° C. (e.g., about 50 to 180° C.). Incidentally, it is advantageous from the viewpoint of strength and rigidity of a sheet that the glass transition temperature of at least one resin among the constituting resins is not less than 50° C. (e.g., about 70 to 200° C.), preferably not less than 100° C. (e.g., about 100 to 170° C.). The weight-average molecular weight can be selected within not more than 1,000,000 (e.g., about 10,000 to 1,000,000), preferably about 10,000 to 700,000.

A plurality of resins can be suitably combined according to a production process. For example, in dry phase separation process by heating a solid phase containing a plurality of resins to spinodal decomposition, resins which are partial-compatible with each other can be combined. While, in wet phase separation process by evaporating or removing a solvent from a liquid phase containing a plurality of resins to spinodal decomposition, a light-scattering layer which is substantially isotropic and has a regular phase structure can be formed regardless of compatibility of a plurality of resins in principle. Usually, for the purpose of controlling a phase separation structure by spinodal decomposition with ease to form a regular phase structure efficiently, a plurality of resins which are not compatible (phase separable) with each other are combined in many cases.

A plurality of resins can comprise a first resin and a second resin in combination. The first and second resins each may comprise a sole resin or plural resins. The combination of the first and second resins is not particularly limited. For example, when the first resin is a cellulose derivative (e.g., a cellulose ester such as cellulose acetate propionate, (meth)acrylic resin such as polymethyl methacrylate), the second resin may be a styrenic resin (e.g., polystylene, stylene-acrylonitrile copolymer), an alicyclic olefinic resin (e.g., a polymer formed from norbornene as a monomer), a polycarbonate-series resin, a polyester-series resin (e.g., the above-mentioned polyC₂₋₄alkylene arylate-series copolyester) or the like.

The ratio of the first resin to the second resin can be selected within the range of, for example, the former/the latter=about 10/90 to 90/10 (weight ratio), preferably about 20/80 to 80/20 (weight ratio), more preferably about 30/70 to 70/30 (weight ratio). In particular, it is advantageous for the purpose of forming the light-scattering layer having the phase separation structure that the ratio of the first to second resins is controlled and the ratio is, for example, the first resin/the second resin=about 80/20 to 40/60 (weight ratio), preferably about 75/25 to 50/50 (weight ratio). Incidentally, when the sheet comprises three or more resins, the amount of each resin can be usually selected within about 1 to 90% by weight (e.g., about 1 to 70% by weight, preferably about 5 to 70% by weight, more preferably about 10 to 70% by weight).

The light-scattering layer constituting the transmittable light-scattering sheet of the present invention is capable of scattering an incident light substantially isotropically and transmitting the light. Moreover, the light-scattering layer has the specific ratio of a linearly transmitted light to an incident light (linearly transmittance), and has a phase separation structure having the specific average interphase distance under an atmosphere for use (in particular, a room temperature of about 10 to 30° C.). That is, the linearly transmittance of the light-scattering layer (e.g., a light-scattering layer in the thickness of 8 to 15 μm) is about 0.1 to 15%, preferably about 0.1 to 13% (e.g., about 0.5 to 12%), more preferably about 1 to 12%, in particular about 2 to 11% (e.g., about 3 to 10%).

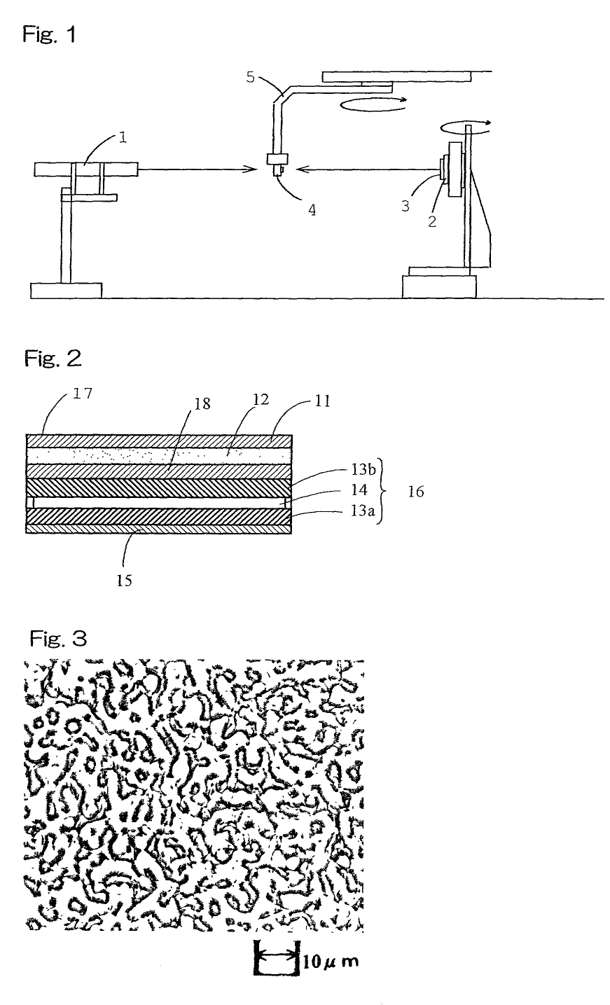

Incidentally, linearly transmittance can be measured with a scattering-measuring instrument shown in FIG. 1 (manufactured by Chuo Seiki, Co., Ltd.). This measuring instrument comprises a light source unit 1 capable of oscillating non-polarized laser of wavelength of 543 nm, a sample stand 2 capable of putting a sample (light-scattering sheet) 3 thereon, a light-receiving unit 4 capable of receiving a laser beam from the light source unit land composed of a photodiode. Incidentally, the sample stand 2 is capable of revolving. Further, the light-receiving unit 4 can be disposed on a light path of a laser beam, and disposed on backside or frontside of the sample stand 2 by revolution of an arm 5. Therefore, by putting the light-receiving unit 4 on backside of the sample stand 2, a laser beam transmitting through the light-scattering sheet 3 on the sample stand 2 can be detected by the photodiode. Moreover, by putting the light-receiving unit 4 between the light source unit 1 and the sample stand 2, the light-receiving unit 4 confronts the sample stand 2, and a reflected light from the light-scattering sheet 3 can be also detected by the photodiode.

In such a device, the intensity of transmitted light A is determined by putting the light-receiving unit on the backside of the sample stand, disposing a slit having diameter of 5 mm and 35% of ND filter on the front of the light-receiving unit, radiating a laser in a direction normal to the light-scattering sheet on the sample stand, and light-receiving a transmitted light in the light-receiving unit disposed on a light path of a laser beam. Incidentally, the diameter of laser beam is 0.1 mm, and the distance between the light-scattering sheet as a sample and the light-receiving unit is 30 cm. Then, the light-scattering sheet is taken off from the sample stand, and a transmitted light B is determined in similar manner mentioned above. In consideration of the transmitted light decay due to interfacial reflection of the light-scattering sheet, the linearly transmittance can be calculated by the following formula:

Linearly transmittance (%)=(1/0.9216)×(A/B)

The phase separation structure of the light-scattering sheet is not particularly limited as far as the phase separation structure has the specific average interphase distance (average periodicity), and may be a structure formed by spinodal decomposition, for example, a bicontinuous phase structure or an intermediate structure having a droplet structure together with the bicontinuous phase structure. The preferred phase separation structure comprises at least a bicontinuous phase structure. The bicontinuous phase structure form is not particularly limited and may be a network structure.

It is considered that the phase separation structure has a regularity of interphase distance (distance between the same phases). In the phase separation structure, an average interphase distance (average periodicity) is, for example, about 3 to 15 μm, preferably about 3 to 12 μm, more preferably about 3.5 to 11 μm (e.g., about 5 to 11 μm). Incidentally, the average interphase distance can be calculated with the use of a photomicrograph (e.g., a transmission microscope, a phase-contrast microscope, a confocal laser microscopic picture) of the light-scattering layer or light-scattering sheet. Usually the phase separation structure is substantially isotropic, with diminishing anisotropy within the film or sheet plane. The term “isotropy” means that an average interphase distance of the phase separation structure is uniform in all directions within the sheet plane.

Such a light-scattering layer represents the unique light-scattering property in relationship between the scattering intensity of the transmitted light and the scattering angle. That is, the light-scattering layer expresses a light-scattering intensity profile having a substantially flat area at scattering angles (the scattering angle range on both side of the scattering center) of about 3 to 12°, preferably about 3 to 10°, more preferably about 3 to 9°, in particular, about 4 to 8° from the scattering center (a position of the scattering angle θ=0°) throughout the light-scattering layer. Incidentally, in respect to the light-scattering intensity distribution, the light-scattering intensity profile which does not have any scattering peak and has a smooth area, or a shoulder or carve area sloping gently from scattering center formed in the scattering angle range on both sides of scattering center, is also regarded as having an uniform or flat area. Moreover, in a substantially flat area showing the uniform light-scattering intensity around a scattering center (at a scattering angle of θ=0°), fluctuation width of light-scattering intensity is about 0 to 20 (preferably about 0 to 15, more preferably about 0 to 10) when a maximum light-scattering intensity is 100.

Moreover, since the light-scattering layer expresses a light-scattering intensity profile having a substantially flat area, uniform brightness can be ensured even at a wide scattering angle. For example, in the light-scattering layer, an angle range showing an 80% or more of intensity relative to maximum light-diffusing intensity is about 8 to 25°, preferably about 9 to 23°, more preferably about 10 to 22°.

The light-scattering property (relationship between the light-scattering intensity and the scattering angle) can be determined with an instrument represented in FIG. 1. For example, the light-receiving unit 4 is disposed on a light path between the laser light source 1 and the sample stand 2 by revolving arm 5. A slit having the diameter of 5 mm is disposed forwardly of the photodiode of the light-receiving unit 4, and the sample (a reflector in which the light-scattering sheet is adhered to a reflecting plate made of aluminum) is disposed on the sample stand 2. The light-diffusing intensity against angles is measured by radiating a laser in a direction normal to the reflector, and defining an angle in direction of regular reflection of laser beam as θ=0°. Incidentally, the light-diffusing intensity in vicinity of direction of regular reflection (around angle of θ=0°) can not be determined because of interrupting a laser beam from laser light source unit 1 by the light-receiving unit 4. Therefore, within the angle range of −10 to 10°, the light-diffusing intensity is measured by revolving the sample stand 2 in angle of 10°. Incidentally, the light-scattering intensity at angle θ=0° is not determined because of overlapping interphase reflection of the sample. Moreover, the light intensity determined thus is standardized based on the light-diffusing intensity of the standard white plate.

Since the light-scattering layer expresses the light-scattering intensity profile having an uniform or flat area, the whole display surface can be uniformly illuminated, and the display surface can be lightened uniformly even when the viewing angle varies. Further, since the light-scattering layer has the above property, rainbow-colored is not given, and the quality of appearance is high.

The total light transmittance value (transparency) of the light-scattering sheet is, for example, about 70 to 100%, preferably about 80 to 100%, more preferably about 90 to 100%. Incidentally, the total light transmittance value can be measured by a hazeometer (manufactured by Nippon Densyoku Kogyo Co. Ltd., NDH-300A).

Incidentally, the light-scattering sheet may comprise a light-scattering layer alone, and may be a laminated sheet according to the species and utilization type of a liquid crystal display device. The laminated sheet may be a laminated sheet comprising a transparent support (a substrate sheet or film) and/or a reflective support, and a light-scattering layer laminated on at least one side of the support. That is, in reflective liquid crystal display device, when a reflective means is used in integration, a laminated sheet comprising the reflecting means and the light-scattering sheet may be used. In the reflective and backlight liquid crystal display device, when the light-scattering sheet is disposed on a light path, a laminated sheet comprising the transparent support and the light-scattering sheet may be used, and a laminated sheet comprising at least two kinds of light-scattering layers (or sheets) may be used. Moreover, an incident light transmits plural times (at least twice) to the light-scattering layer so that an area where the light-diffusing intensity is uniform or flat appears in respect to the light-scattering property. Therefore, the flat area in the light-scattering intensity profile can appear by laminating the light-scattering or the light-scattering sheet on at least one side of the reflective support, a light being incident to the light-scattering layer, and reflecting the incident light, which is transmitted through the light-scattering sheet, on the reflective support. Moreover, the flat area in the light-scattering intensity profile may appear by laminating two light-scattering layers or light-scattering sheet, if necessary, via the transparent support and transmitting an incident light once.

As a resin constituting the transparent support (support sheet), the resin similar to that of the light-scattering layer can be used. As the preferred resin constituting the transparent support, there may be mentioned, for example, cellulose derivatives (e.g., a cellulose acetate such as cellulose triacetate (TAC) and cellulose diacetate), polyester-series resins (e.g., polyethylene terephthalate (PET), polybutylene terephthalate (PBT), polyarylate-series resins), polysulfone-series resins (e.g., polysulfone, polyether sulfone (PES)), polyether ketone-series resins (e.g., polyether ketone (PEK), polyether ether ketone (PEEK)), polycarbonate-series resins (PC), polyolefinic resins (e.g., polyethylene, polypropylene), a cyclic polyolefinic resins (e.g., ARTON, ZEONEX), halogen-containing resins (e.g., vinylidene chloride), (meth)acrylic resins, styrenic resins (e.g., polystyrene), vinyl ester or vinyl alcohol-series resins (e.g., polyvinyl alcohol). The transparent support may be stretched monoaxially or biaxially, and the transparent support having an isotropy optically is preferred. The preferred transparent support is a support sheet or film having low birefringence. The optically isotropic transparent support includes non-stretched sheet or film, and includes a sheet or film composed of, for example, polyesters (e.g., PET, PBT), cellulose esters, in particular cellulose acetates (e.g., cellulose acetate such as cellulose diacetate and cellulose triacetate, cellulose acetate C₃₋₄alkylcarboxylic acid ester such as cellulose acetate propionate and cellulose acetate butylate) or the like.

As the reflective support, there may be mentioned, for example a light-reflective metal foil such as aluminum, silver and gold, a light-reflective metal plate such as aluminum plate, a metal-vapor deposition plate in which the metal is vapor deposited on a substrate (e.g., plastic, cellamic, substrate made of a metal), a metal-vapor deposition layer composed of the metal and the like. The metal-vapor deposition layer may be formed on a surface of the light-scattering layer or the light-scattering sheet.

The thickness of the light-scattering layer or the light-scattering sheet may be, for example, about 0.5 to 300 μm, preferably about 1 to 100 μm (e.g., about 10 to 100 μm), more preferably about 1 to 50 μm (e.g., about 5 to 50 μm, in particular, about 10 to 50 μm). Incidentally, when the light-scattering sheet comprises the support and the light-scattering layer, the thickness of the light-scattering layer may be, for example, about 1 to 50 μm (e.g., about 5 to 50 μm), preferably about 5 to 30 μm(e.g., about 8 to 20 μm), and even in the thickness of about 8 to 15 μm, high light-scattering property is usually obtained.

Incidentally, the light-scattering layer or the light-scattering sheet of the present invention may be laminated on, for example, a member constituting a liquid crystal display device (in particular, an optical member) such as a polarizing plate or an optical retardation plate for coloration and high-definition of a liquid crystal image, if necessary.

The light-scattering sheet may contain a variety of additives, for example, a stabilizer (e.g. antioxidant, ultraviolet absorber, heat stabilizer, etc.), a plasticizer, a colorant (a dye or a pigment), a flame retardant, an antistatic agent and a surfactant. Moreover, where necessary, the surface of the light-scattering sheet may be formed with various coating layers, such as an antistatic layer, an antifogging layer and a parting (release) layer.

[Method of Producing a Light-Scattering Sheet]

The light-scattering sheet of the present invention (transmittable light-scattering sheet) can be produced by a variety of methods, for example, a spinodal decomposition method. The spinodal decomposition method may be a polymerization-phase separation method by polymerizing a polymerizable composition containing a plurality of monomers or oligomers and an polymerization initiator with active ray (e.g., ultraviolet) or heat to cause a phase separation accompanied with polymerization, or a dry spinodal decomposition method by heating a solid phase containing a plurality of resins to form a phase separation structure, but a wet spinodal decomposition method is preferred. In the wet spinodal decomposition method, the light-scattering layer or sheet can be produced by evaporating or removing a solvent from a liquid phase containing a plurality of resins differing in refractive index with each other (e.g., liquid phase at an ordinary temperature, for example, a mixture liquid or a solution) to form a phase separation structure which is substantially isotropic due to spinodal decomposition.

More concretely, the light-scattering sheet composed of the light-scattering layer alone can be produced by casting the mixture liquid on a release support, evaporating a solvent in the mixture liquid to cause phase separation due to spinodal decomposition, forming the light-scattering layer having the phase separation structure, fixing the layer, and peeling the light-scattering layer from the release support. Moreover, the light-scattering sheet comprising the support (e.g., transparent substrate sheet) and the light-scattering layer can be produced by coating the mixture liquid on the transparent support, evaporating a solvent in mixture liquid to cause phase separation due to spinodal decomposition, forming the phase separation structure, and fixing the structure, or by laminating the light-scattering layer on the transparent support (transparent substrate sheet) by means of a laminate method such as adhesion.

The mixture liquid containing a plurality of resins is usually used as a solution in which the resins are dissolved in a common solvent (in particular, homogenous solution). Incidentally, in the wet spinodal decomposition method, the light-scattering layer having the above phase separation structure can be formed regardless of compatibility of the constituting resins in principle. Thus, the method can be effectively adopted to a resin system which can not adopted to the dry spinodal decomposition method, for example, the constituting resins which are not compatible with each other by kneading at a temperature of not more than decomposition temperature of the resins. The above common solvent can be selected from solvents capable of dissolving each resin according to the species and the solubility of the resins, and may be, for example, water, an alcohol (e.g., ethanol, isopropanol, butanol, cyclohexanol), an aliphatic hydrocarbon (e.g., hexane), an alicyclic hydrocarbon (e.g., cyclohexane), an aromatic hydrocarbon (e.g., toluene, xylene), a halogenation hydrocarbon (e.g., dichloromethane, dichloroethane), an ester (e.g., methyl acetate, ethyl acetate, butyl acetate), an ether (e.g., dioxane, tetrahydrofurane), a ketone (e.g., acetone, methyl ethyl ketone, methyl isobutyl ketone), a cellosolve (e.g., methyl cellosolve, ethyl cellosolve), a cellosolve acetate, a sulfoxide (e.g., dimethyl sulfoxide), an amide (e.g., dimethylformamide, dimethylacetoamide), and the solvent may be a mixed solvent.

After the mixture liquid is cast or coated, a spinodal decomposition can be carried out by evaporating or removing a solvent at a temperature of less than a boiling point of the solvent (e.g., a temperature lower than a boiling point of the solvent by about 1 to 120° C., preferably about 5 to 50° C., in particular about 10 to 50° C.) to cause the phase separation of a plurality of resins to spinodal decomposition. The removal of the solvent can be usually carried out by drying, for example drying at an temperature of about 30 to 100° C., preferably about 40 to 80° C. according to the boiling point of the solvent.

The concentration of a solute (resin) in mixture liquid can be selected within the range causing the phase-separation and not deteriorating castability and coating property, and is, for example, about 1 to 40% by weight, preferably about 2 to 30% by weight (e.g., about 2 to 20% by weight), more preferably about 3 to 15% by weight, and is usually about 5 to 25% by weight.

The phase separation structure formed by spinodal decomposition can be fixable by cooling to a temperature of not more than a fixing temperature or a glass transition temperature of the constituting resin (e.g., not more than a glass transition temperature of the main resin).

The phase separation structure can be formed by a simple operation of removal and dryness of a solvent without heating treatment at high temperature because of utilizing spinodal decomposition by removing a solvent.

Incidentally, the mixture liquid is coated on a transparent support, and the transparent support sometimes dissolves or swells according to the species of solvents. For example, when a coating liquid (homogenous solution) containing a plurality of resins is coated on triacetylcellulose film, the coating surface of triacetylcellulose film sometimes elutes, corrodes, or swells according to the species of solvents. In this case, it is advantageous that a coating surface of the transparent support (e.g., triacetylcellulose film) is previously applied with a coating agent for solvent resistance to form an optically isotropic coating layer for solvent resistance. Such a coating layer can be formed with, for example, thermoplastic resins such as AS resin, polyester-series resins, and polyvinyl alcohol-series resins (e.g., polyvinyl alcohol, ethylene-vinyl alcohol copolymer), curable resins such as epoxy resins, silicone-series resins, and ultraviolet-curable resins, hard-coating agents or the like.

Incidentally, when a mixture liquid or coating liquid containing a plurality of resins is coated on a transparent support, a solvent in which the transparent support does not dissolve, corrode or swell may be selected according to the species of the transparent support. For example, when triacetylcellulose film is employed as the transparent support, tetrahydrofuran, methyl ethyl ketone or the like is used as a solvent for the mixture liquid or the coating liquid and thus the light-scattering layer can be formed without deteriorating properties of the film.

[Liquid Crystal Display Device]

The light-scattering sheet of the present invention is applied to a variety of display devices, in particular, liquid crystal display device. The liquid crystal display device comprises a liquid crystal cell having a liquid crystal sealed therein, a lightening means for illuminating the liquid crystal cell due to reflection or emergence, which is disposed behind the liquid crystal cell, and the light-scattering sheet disposed forwardly of the lightening means.

More concretely, a backlight-type liquid crystal display device comprises a liquid crystal cell having a liquid crystal sealed therein, and a surface light source unit (or backlight unit) for illuminating the liquid crystal cell disposed behind the liquid crystal cell. This surface light source unit (or plane or flat light source unit) comprises, for example, a tubular light source such as fluorescent tube (cold cathode tube) disposed adjacent to the lateral side of a light guide, the light guide for guiding a light from the tubular light source to the liquid crystal cell, and a reflector disposed on the opposite to the liquid crystal cell side of the light guide.

Since such a liquid crystal display device and a surface light source unit uniformly illuminate the liquid crystal cell from its backside by reflecting a light from the tubular light source with the reflector and guiding the light with the light guide, a plurality of light-scattering sheets (especially, two light-scattering sheets) are ordinarily disposed on a light path (emergence path from the tubular light source) between the tubular light source and the liquid crystal cell (in particular, between the light guide and the liquid crystal cell). The position for disposing the light-scattering sheet is not particularly limited, and, for example, at least two light-scattering sheet in total can be disposed at a position selected from a position between the light guide and liquid crystal cell, a surface of the light guide, a backside surface of the liquid crystal cell, a surface of the liquid crystal cell and the like.

Incidentally, since a backlight-type liquid crystal display device can uniformly illuminate the liquid crystal cell even when using a tubular light source having an anisotropy in the distribution of light intensity, a light-scattering sheet which is anisotropic in respect to the light-scattering property may be disposed between the light guide and the liquid crystal cell. In the anisotropic light-scattering sheet, the light-scattering intensity of Y-axis direction is higher than that of X-axis direction. Therefore, when it is assumed that the axis-direction of the tubular light source is X-direction, the anisotropic light-scattering sheet is usually disposed in such direction that Y-axis of the anisotropic light-scattering sheet is perpendicular to X-direction of the tubular light source.

The transmittable light-scattering sheet of the present invention is preferably applied to a reflective liquid crystal display device equipped with a reflecting means, in particular, a reflective liquid crystal display device equipped with a reflecting means and a polarizing means. For example, the liquid crystal display device is not limited to a one polarizing plate-type reflective LCD device with one polarizing plate, and may be a two polarizing plates-type reflective LCD device with two polarizing plates varying in polarizing property. The reflective LCD device utilizing one polarizing plate may be a reflective LCD device combining one polarizing plate with a variety of modes (e.g. the mode using a twisted nematic liquid crystal, a R-OCB (optically compensated bend) mode, a parallel alignment mode, etc.).

Moreover, the light-scattering sheet of the present invention can be also applied to a reflective LCD device utilizing the wavelength selectivity in the reflection property of a chiral nematic liquid crystal.

The reflective liquid crystal display device comprises a liquid crystal cell having a liquid crystal sealed therein, a reflecting means for reflecting an incident light, which is disposed behind the liquid crystal cell, and the light-scattering sheet disposed forwardly of the reflecting means. In a display device having such a construction, at least one light-scattering sheet mentioned above is disposed on a light path of an incident light (an incident path or a reflecting path) and the light is incident or emerges onto the light-scattering layer, so that the display surface can be uniformly illuminated due to flat or uniform light-scattering property. Therefore, one light-scattering sheet may be disposed on the light path, for example, between the reflecting means and the liquid crystal cell, the backside of the liquid crystal cell, the surface of the liquid crystal cell, the surface of the reflecting means, or the like. Moreover, when the polarizing plate is disposed forwardly of the liquid crystal cell, the light-scattering sheet may be disposed between the liquid crystal cell and the polarizing plate.

FIG. 2 is a schematic cross-section view showing an example of the reflective LCD device. This LCD device comprises a liquid crystal cell 16 having a liquid crystal (e.g., liquid crystal layer) 14 sealed between a pair of transparent substrates (e.g., glass plate, plastic) 13a, 13b, a reflecting means (e.g., a reflective layer such as specular reflecting plate) 15 laminated on one transparent substrate (back substrate) 13a of the transparent substrates 13 constituting the liquid crystal cell, a light-scattering sheet 12 laminated on the other transparent substrate (front substrate) 13b constituting the liquid crystal cell 16 via a coloring means for color display (e.g., a color filter) 18, and a polarizing means (e.g., a polarizing layer such as polarizing plate) 11 for polarizing a light reflected by the reflecting means 15, which is laminated on the light-scattering sheet. Transparent electrodes (not shown) are formed on the opposed surfaces of the pair of transparent substrates 13a and 13b.

In such a reflective LCD device, a light incident from a front surface 17 on the viewer side (a incident light) is diffused through the light-scattering sheet and reflected by the reflecting means 15, and the reflected light is rescattered through the light-scattering sheet 12. Therefore, in the reflective LCD device having the light-scattering sheet 12, in respect to light-scattering intensity profile, a flat area having the uniform intensity appears, a display having an uniform brightness can be realized even when viewing angle changes. Moreover, the whole of the display screen can be lightened, the sufficient brightness can be ensured even in color display, and the sharp color image can be exhibited in the color display-type reflective LCD device.

Incidentally, in the reflective liquid crystal display device, the position for disposing the light-scattering sheet is not particularly limited as far as a reflecting means for reflecting an incident light toward back side of the liquid crystal cell is disposed and the light-scattering sheet is disposed forwardly of the reflecting means. Moreover, it is sufficient that the polarizing plate may be disposed on a light path (incident path and/or emerge path). The position for disposing the polarizing means and the light-scattering sheet is not particularly limited and the light-scattering sheet may be disposed forwardly of the polarizing means. In the preferred embodiment, in order to illuminate a display screen by the polarizing means, the polarizing means is disposed forwardly of the liquid crystal cell, and the light-scattering sheet is disposed between the liquid crystal cell and the polarizing plate.

The reflecting means can be formed with a thin film such as vapor deposition film made of aluminum, and a transparent substrate, a color filter, a light-scattering sheet, and a polarizing plate may be laminated with an adhesive layer. That is, the light-scattering sheet of the present invention may be used with laminating the other functional layer (e.g., a polarizing plate, an optical retardation, light-reflecting plate, a transparent conductive layer). Incidentally, when the reflective LCD device is employed as a monochrome display device, the above color filter is not always required.

Moreover, an optical retardation plate may be disposed in an STN (Super Twisted Nematic) liquid crystal display device, though this is not indispensable in a TFT liquid crystal display device. The optical retardation plate may be disposed on a suitable position, for example, between the front transparent substrate and the polarizing plate. In this device, the light-scattering sheet may be interposed between the polarizing plate and the optical retardation plate, and may be interposed between the front transparent substrate and the optical retardation plate.

By using the light-scattering sheet of the present invention, the display surface can be illuminated uniformly. In particular, even when a viewing angle changes and a surface area of the liquid crystal display is large, the highly brightness can be realized throughout the display surface. Therefore, the LCD device can be utilized broadly in the display segments of electrical and electronic products such as personal computers, word processors, liquid crystal televisions, cellular phone, chronometers, desktop calculators. Especially, it is preferably utilized in a liquid crystal display device of a portable information terminal.

According to the present invention, since the light-scattering layer has the specific linearly transmittance and phase separation structure, the high directionality can be imparted to a transmitted light, and the display surface having uniform brightness can be realized. Moreover, in respect to light-scattering intensity profile, since a flat area in which a light-scattering intensity is uniform around the scattering center appears, an uniform brightness of the display surface can be ensured even when the viewing angle changes. Further, even in the large display surface area and a color display, the display surface can be illuminated uniformly.

### EXAMPLES

The following examples illustrate the present invention in further detail without defining the scope of the invention.

### Example 1

Polymethyl methacrylate (PMMA, manufactured by Mitsubishi Rayon Co. Ltd., BR-80, 63 parts by weight) and 37 parts by weight of styrene-acrylonitrile copolymer (SAN, manufactured by Techno Polymer Co. Ltd., 290ZF) were dissolved in ethyl acetate to prepare 10% by weight of resin solution. The resin solution was cast on a glass substrate to form a transparent film having thickness of 11.3 μm. The film together with the substrate was heated in an oven at a temperature of 220° C. for 28 minutes and was allowed to stand in the air for cooling to room temperature. The resulting film having the thickness of 11.3 μm (light-scattering sheet) was cloudy white.

### Comparative Example 1

Crosslinked urethane fine particle (crosslinked PU particle, 10 parts by weight) having a mean particle size of 3.5 μm and 90 parts by weight of polymethyl methacrylate were dissolved in ethyl acetate and cast to obtain a light-diffusing sheet having a thickness of 50 μm.

### Examples 2 to 6

A film (light-scattering sheet) was prepared in similar manner to Example 1 except for preparing a film under conditions shown in Table 1 (the coating thickness of the resin solution, heating time).

### Examples 7 to 11

Polymethyl methacrylate (PMMA, manufactured by Mitsubishi Rayon Co. Ltd., BR-87, 70 parts by weight) and 30 parts by weight of styrene-acrylonitrile copolymer (SAN, manufactured by Techno Polymer Co. Ltd., SAN-L) were dissolved in methyl ethyl ketone (MEK) to prepare 10% by weight of resin solution. A film (light-scattering sheet) was prepared in similar manner to Example 1 except for forming a film under conditions shown in Table 1 (the coating thickness of the resin solution, heating temperature, heating time).

### Comparative Example 2

A film (light-scattering sheet) was prepared in similar manner to Example 7 except the thickness (thickness after drying) of the film was 10.3 μm and the heating time was 9 minutes.

### Comparative Example 3

95 parts by weight of a flake of cellulose triacetate (TAC, manufactured by Daicel Chemical Industries, Ltd., LT-105) was dissolved in 90 parts by weight of a mixed solvent of methylene chloride/methanol (9/1 weight ratio). To the solution was mixed 5 parts by weight of crosslinked polystyrene fine particle (crosslinked PS particle) and cast to obtain a light-scattering sheet having a thickness of 50 μm.

[Phase Separation Structure]

When the structure of the light-diffusing sheet was examined with a transmission optical microscope, the phase separation structures of films in Examples 1 to 11 and Comparative Example 2 were found to have a bicontinuous phase structure. When the sheets of Comparative Examples 1 and 3 were examined with a transmission optical microscope, the sheet was found to have a random droplet phase structure.

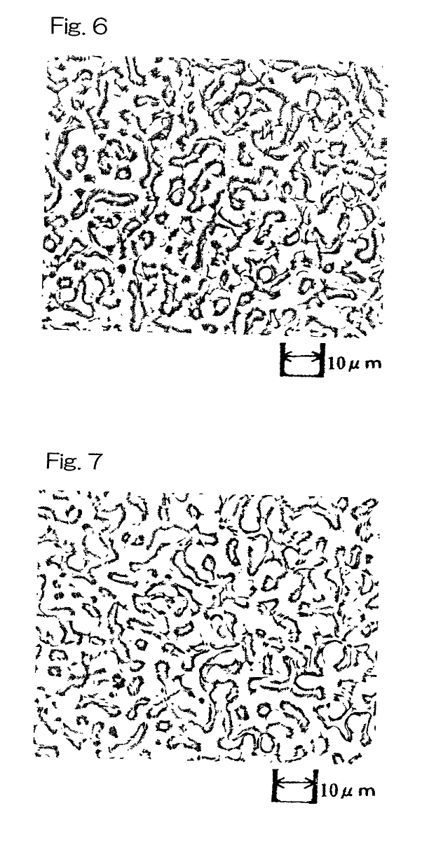

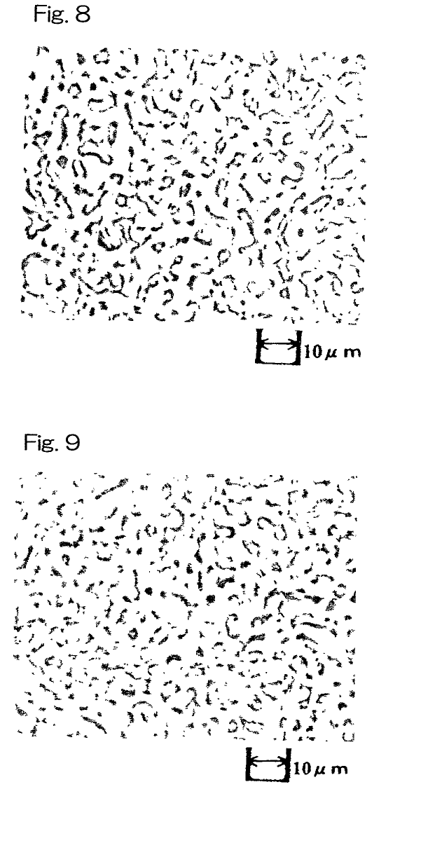

The transmission optical microscope photograph of the phase separation structure of the film obtained in Example 1 was shown in FIG. 3. The transmission optical microscope photographs of the phase separation structures of the films obtained in Examples 2 to 6 were shown in FIGS. 5 to 9, respectively.

[Average Interphase Distance (Average Periodicity)]

When the average interphase distance (average periodicity) in an optional direction was measured, that of the film in Example 1 was 7 μm.

[Linearly Transmittance]

The film was peeled from the glass plate, and the linearly transmittance was determined with the measuring instrument shown in FIG. 1.

[Reflective Diffusing Property]

The film was stuck on an aluminum reflector and the reflective diffusing property was determined with the measuring instrument shown in FIG. 1. Incidentally, the light-diffusing intensity is a relative value in respect to the reflective diffusing property showing the relationship between the light-diffusing intensity and the diffusing angle θ.

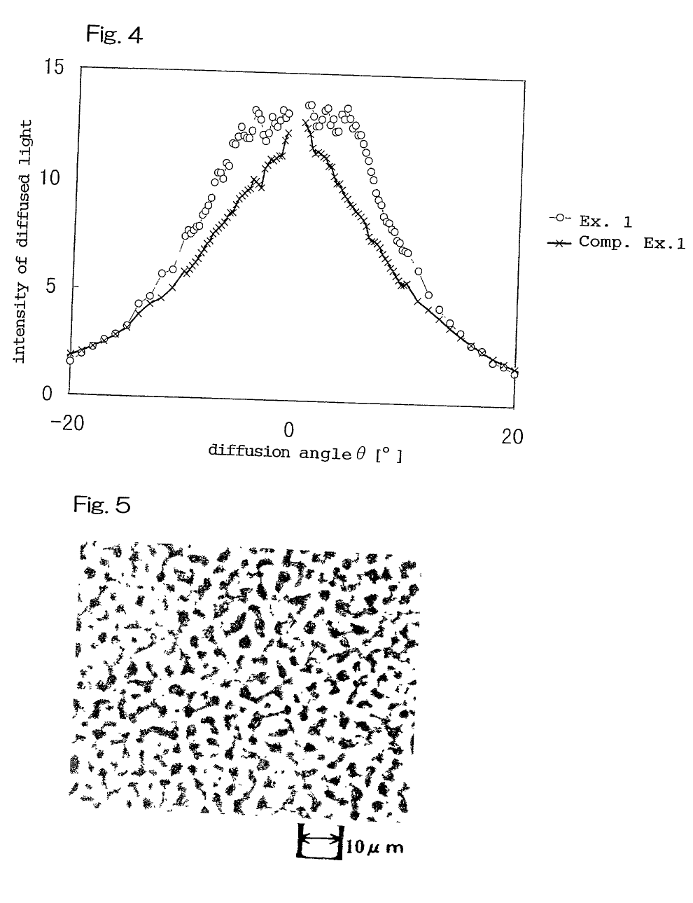

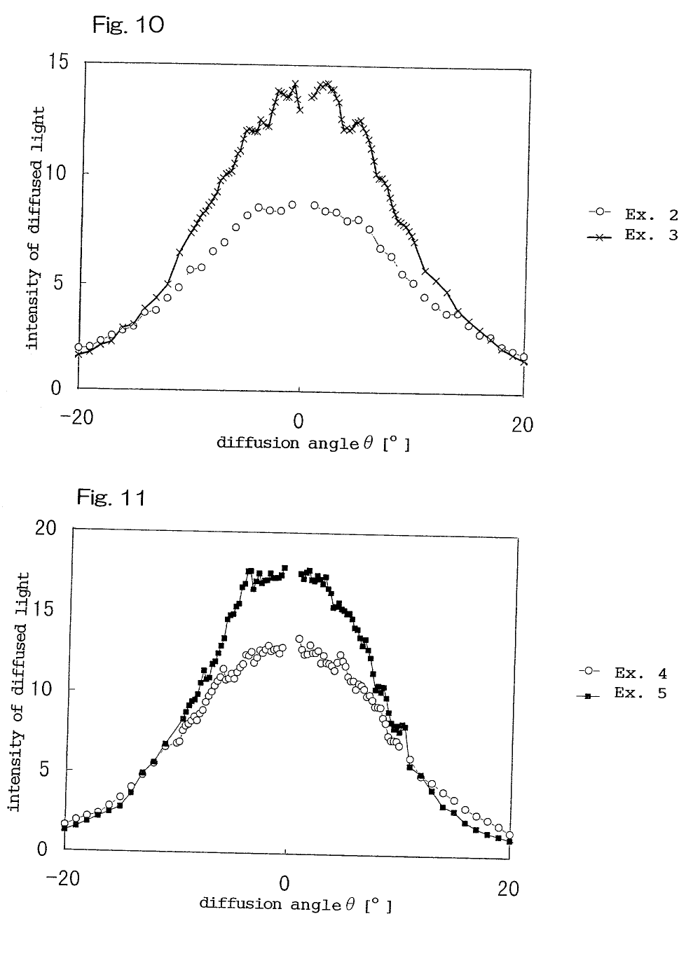

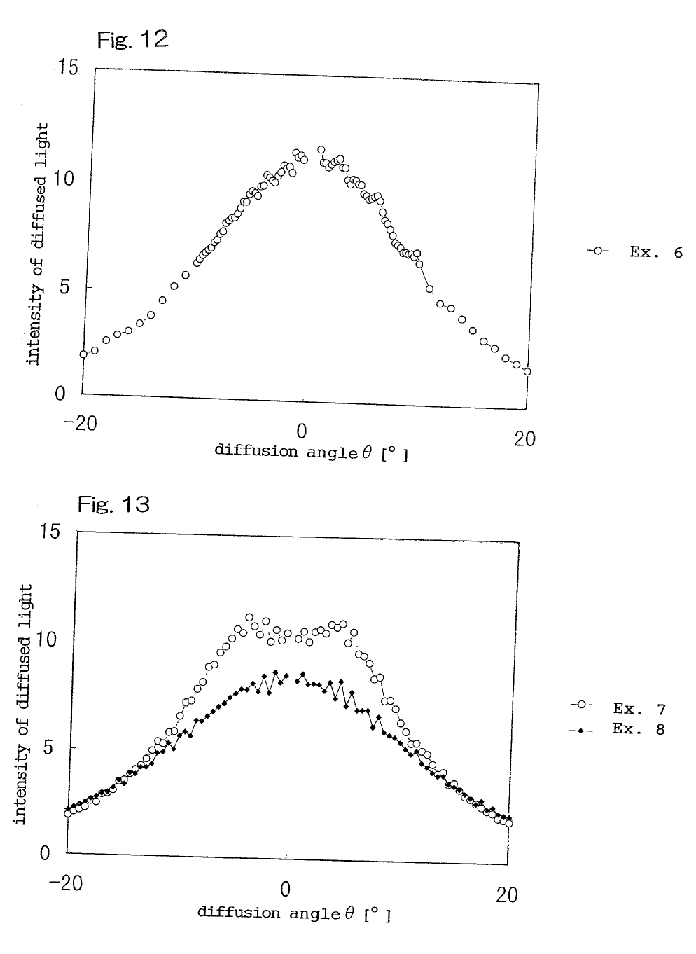

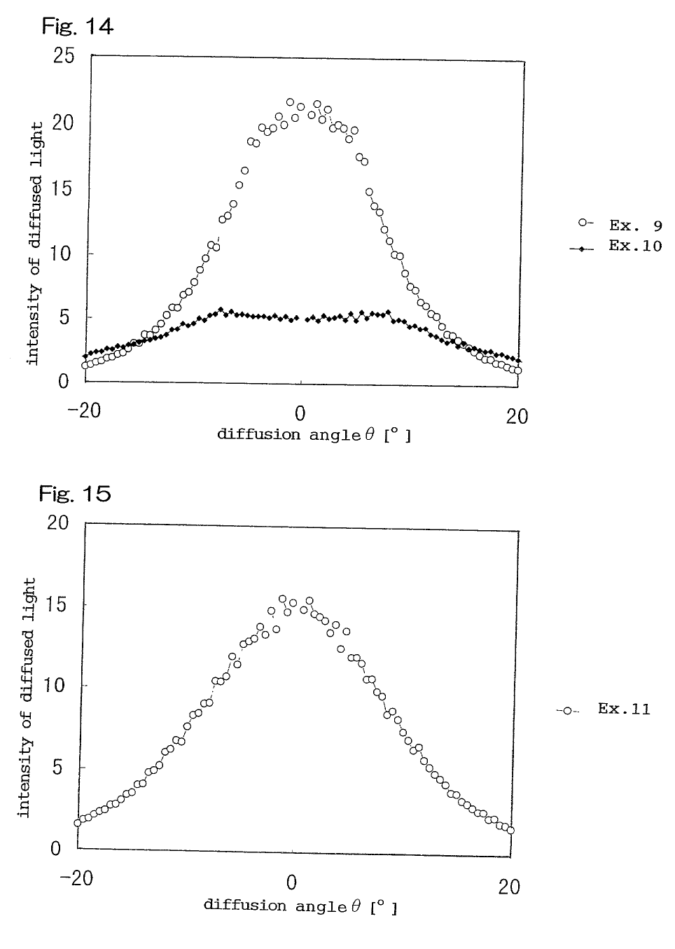

The reflective diffusing properties of the films obtained in Example 1 and Comparative Example 1 are shown in FIG. 4. Moreover, the reflective diffusing properties of the films obtained in Examples 2 to 6 are shown in FIGS. 10 to 12, respectively. The reflective diffusing properties of the films obtained in Examples 7 to 11 are shown in FIGS. 13 to 15, respectively.

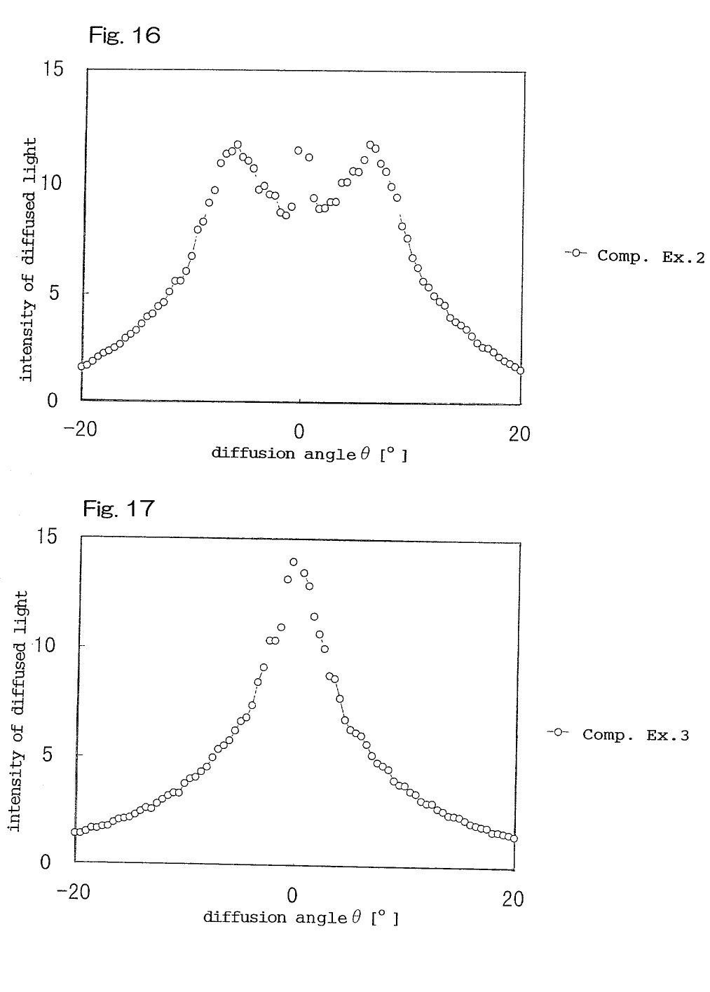

As shown in Figures, the films obtained in Examples showed the light-diffusing property retaining the almost constant diffusing intensity over wide angle range bridging the front reflection direction (θ=0°). For example, as shown in FIG. 4, the film of Example 1 expressed the light-diffusing property (profile) retaining the almost constant diffusing intensity over scattering angles of ±50 crossing a direction of the front reflection (θ=0°). On the other hand, as shown in FIG. 4, the light-diffusing sheet of Comparative Example 1 showed such light-diffusing property that the diffusing intensity elevates or increases as closing to a direction of the front reflection (the diffusing angle θ=0°). Moreover, as shown in FIG. 16, the light-scattering sheet of Comparative Example 2 had a peak of the light-diffusing intensity at the specific diffusing angle not being uniform light-diffusing property (profile). Further, as shown in FIG. 17, the light-diffusing sheet obtained in Comparative Example 3 had a peak of the light-diffusing intensity at the diffusing angle θ=0° not being uniform light-diffusing property.

[Reflection of Light Source Configuration]

Each of the light-diffusing sheets of Examples 1 to 11 and Comparative Examples 1 to 3 was stuck on an aluminum reflector and put under a fluorescent lamp stand on table, and the degree of reflection of the light source configuration (or image) was visually evaluated according to the following criteria.

A: the light source configuration is hardly reflected (by light-scattering of the sheet)

B: the light source configuration is reflected to some extent but not noticeably

C: the light source configuration is strongly reflected

The production process of the film (light-scattering sheet) is shown in Table 1, and the results are shown in Table 2.

TABLE 1

| | | | Components 1/2 | | | | Heating | |
|---|---|---|---|---|---|---|---|---|
| | | | ratio | | Concentration | Thickness of | Temperature | Heating time |
| | Component 1 | Component 2 | [weight ratio] | Solvent | [% by weight] | the film [μm] | [° C.] | [minute] |
| Ex. 1 | PMMA | SAN | 63/37 | ethyl acetate | 10 | 11.3 | 220 | 28 |
| Comp. Ex. 1 | crosslinked | PMMA | 10/90 | ethyl acetate | 15 | 50 | — | — |
| | PU particle | | | | | | | |
| Ex. 2 | PMMA | SAN | 63/37 | ethyl acetate | 10 | 12.8 | 220 | 23 |
| Ex. 3 | PMMA | SAN | 63/37 | ethyl acetate | 10 | 12.3 | 220 | 32 |
| Ex. 4 | PMMA | SAN | 63/37 | ethyl acetate | 10 | 12.1 | 220 | 28 |
| Ex. 5 | PMMA | SAN | 63/37 | ethyl acetate | 10 | 10.8 | 220 | 28 |
| Ex. 6 | PMMA | SAN | 63/37 | ethyl acetate | 10 | 13.8 | 220 | 32 |
| Ex. 7 | PMMA | SAN | 70/30 | MEK | 15 | 11.0 | 200 | 11 |
| Ex. 8 | PMMA | SAN | 70/30 | MEK | 15 | 13.7 | 200 | 12 |
| Ex. 9 | PMMA | SAN | 70/30 | MEK | 15 | 9.3 | 100 | 17 |
| Ex. 10 | PMMA | SAN | 70/30 | MEK | 15 | 14.1 | 200 | 7 |
| Ex. 11 | PMMA | SAN | 70/30 | MEK | 15 | 12.3 | 200 | 19 |
| Comp. Ex. 2 | PMMA | SAN | 70/30 | MEK | 15 | 10.3 | 200 | 9 |
| Comp. Ex. 3 | crosslinked | TAC | 5/95 | methylene | 10 | 50 | — | — |
| | PS particle | | | chloride/methanal | | | | |

TABLE 2

| | Scattering | Average periodicity | | | Angle range having 80% or more of | |
|---|---|---|---|---|---|---|
| | peak or | of the phase | Linearly | | intensity to maximum intensity of | Reflection of |
| | shoulderangle | separation | transmittance | Maximum intensity | diffused light | light source |
| | [°] | structure [μm] | [%] | of diffused light | [°] | configuration |
| Ex. 1 | 4.5 | 7.0 | 6.6 | 3.7 | 13.0 [−6.5 to 6.5] | B |
| Comp. Ex. 1 | — | — | 4.5 | 12.9 | 7.0 [−3.5 to 3.5] | B |
| Ex. 2 | 5.5 | 5.7 | 7.0 | 8.8 | 14.0 [−7.0 to 7.0] | B |
| Ex. 3 | 4.0 | 7.9 | 3.0 | 14.2 | 11.4 [−5.7 to 5.7] | A |
| Ex. 4 | 4.5 | 7.0 | 4.9 | 13.6 | 13.0 [−6.5 to 6.5] | B |
| Ex. 5 | 4.5 | 7.0 | 7.9 | 17.9 | 11.2 [−5.6 to 5.6] | B |
| Ex. 6 | 4.0 | 7.9 | 1.6 | 11.8 | 11.6 [−5.8 to 5.8] | A |
| Ex. 7 | 5.5 | 5.7 | 12.0 | 11.2 | 14.0 [−7.0 to 7.0] | B |
| Ex. 8 | 5.0 | 6.3 | 3.8 | 8.7 | 13.0 [−6.5 to 6.5] | A |
| Ex. 9 | 3.5 | 9.0 | 8.0 | 21.7 | 10.4 [−5.2 to 5.2] | B |
| Ex. 10 | 8.1 | 3.9 | 12.4 | 5.7 | 21.0 [−10.5 to 10.5] | B |
| Ex. 11 | 3.0 | 10.4 | 1.0 | 15.6 | 10.0 [−5.0 to 5.0] | A |
| Comp. Ex. 2 | 6.6 | 4.8 | 20.0 | 11.8 | 5.5 [3.0 to 8.5] | C |
| Comp. Ex. 3 | — | — | 10 | 14 | 3.0 [−1.5 to 1.5] | B |

As apparent from Table 2, the transmittable light-scattering sheets of Examples are employed so that an uniform light-scattering intensity area appears over a wide angle range and the display surface can be illuminated uniformly even when the viewing angle changes.

What is claimed is:

1. A light-scattering sheet comprising a light-scattering layer which comprises a plurality of resins varying in refractive index and scatters an incident light isotropically, wherein the light-scattering layer has a ratio of a linearly transmitted light to an incident light of 0.1 to 15% and has a phase separation structure having an average interphase distance of 3 to 15 μm.

2. A light-scattering sheet according to claim 1, wherein the light-scattering layer expresses a light-scattering intensity profile having substantially flat area at scattering angle θ of 3 to 12° from a scattering center.

3. A light-scattering sheet according to claim 1, wherein the light-scattering layer have a ratio of a linearly transmitted light to an incident light of 3 to 10%, a phase separation structure having an average interphase distance of 3 to 12 μm and an area where a light-scattering intensity is substantially uniform at scattering angle θ of 4 to 8° from a scattering center.

4. A light-scattering sheet according to claim 1, wherein in the light-scattering layer, the scattering angle range that an intensity of a diffused light is not less than 80% relative to a maximum intensity of a diffused light is 8 to 25° in respect to a light-scattering property.

5. A light-scattering sheet according to claim 1, wherein the light-scattering layer has a phase separation structure composed of a plurality of resins varying in refractive index, and has a bicontinuous phase structure formed by spinodal decomposition or an intermediate structure between the bicontinuous phase structure and a droplet phase structure.

6. A light-scattering sheet according to claim 1, which comprises a transparent or reflective support and the light-scattering layer formed on at least one side of the support.

7. A process for forming the light-scattering layer having the light-scattering properties recited in claim 1, which comprises subjecting a resin layer composed of a plurality of resins varying in refractive index to spinodal decomposition.

8. A liquid crystal display device which comprises a liquid crystal cell having a liquid crystal sealed therein, a lightening means for illuminating the liquid crystal cell due to reflection or emergence disposed behind the liquid crystal cell, and a light-scattering sheet recited in claim 1 disposed forwardly of the lightening means.

9. A liquid crystal display device according to claim 8, which comprises a liquid crystal cell having a liquid crystal sealed therein, a reflecting means for reflecting an incident light disposed behind the liquid crystal cell, and a light-scattering sheet recited in claim 1 disposed forwardly of the reflecting means.

10. A liquid crystal display device according to claim 8, wherein a polarizing plate is disposed forwardly of the liquid crystal cell, and a light-scattering sheet recited in claim 1 is disposed between the liquid crystal cell and the polarizing plate.

11. A light-scattering sheet according to claim 1, wherein the light-scattering layer comprises a first resin selected from the group consisting of a cellulose derivative and a (meth)acrylic resin, and a second resin selected from the group consisting of a styrenic resin, an alicyclic olefinic resin, a polycarbonate-series resin and a polyester-series resin.

12. A light-scattering sheet according to claim 11, wherein the weight ratio of the first resin to the second resin is 10/90 to 90/10.

13. A light-scattering sheet according to claim 1, wherein the light-scattering layer has a ratio of a linearly transmitted light to an incident light of 0.1 to 13%, has a phase separation structure having an average interphase distance of 3 to 12 μm, and expresses a light-scattering intensity profile having substantially flat area at scattering angle θ of 3 to 11° from a scattering center, and wherein the fluctuation width of light-scattering intensity in the flat area is 0 to 20 when a maximum light-scattering intensity is 100.

14. A process according to claim 7, which comprises removing a solvent from a liquid phase composed of a plurality of resins varying in refractive index and subjecting the phase to spinodal decomposition.
